(19) United States
(12) Patent Application Publication
(10) Pub. No.: US 2023/0133362 A1
(43) Pub. Date: May 4, 2023

(54) CONTROL DEVICE, CONTROL SYSTEM, AND NON-TRANSITORY COMPUTER READABLE MEDIUM

(71) Applicant: KABUSHIKI KAISHA TOKAI RIKA DENKI SEISAKUSHO, Aichi (JP)

(72) Inventors: Masateru FURUTA, Aichi (JP); Tadashi FUKAGAI, Aichi (JP); Yuki KONO, Aichi (JP); Yutaka KUBO, Aichi (JP); Yosuke OHASHI, Aichi (JP)

(73) Assignee: KABUSHIKI KAISHA TOKAI RIKA DENKI SEISAKUSHO, Aichi (JP)

(21) Appl. No.: 17/791,361

(22) PCT Filed: Dec. 2, 2020
(86) PCT No.: PCT/JP2020/044787

§ 371 Date: Jul. 7, 2022

(30) Foreign Application Priority Data
Mar. 23, 2020 (JP) 2020-051719

(51) Int. Cl. G01S 13/02; G01S 13/76; B60R 25/24

(52) U.S. Cl. CPC G01S 13/0209; G01S 13/765; B60R 25/245; G01S 2013/466

(57) ABSTRACT

A control device includes a control section configured to obtain one or more distance measurement values, and estimate a relative position of a position changeable type communication device with respect to a target space based on the one or more distance measurement values, the one or more distance measurement values being obtained when one or more position fixed type communication devices and the position changeable type communication device perform wireless communication, and indicating a distance between each of the one or more position fixed type communication devices and the position changeable type communication device.

### TECHNICAL FIELD

The present invention relates to a control device, a control system, and a program.

### BACKGROUND ART

In recent years, various technologies that measure a distance between devices (that may be also referred to as distance measurement below) have been developed. For example, following Patent Literature 1 discloses a technology that measures a distance between devices based on a time (also referred to as a propagation time below) taken until a signal is received after the signal is transmitted.

### CITATION LIST

### Patent Literature

Patent Literature 1: U.S. Pat. No. 9,566,945 A

### SUMMARY OF INVENTION

### Technical Problem

Measuring a distance between devices can be also regarded as estimating a position of the other device for which the one device serves as a reference point. However, it is desirable that the positions of the devices are more finely estimated.

Accordingly, the present invention is made in view of the aforementioned issue, and an object of the present invention is to provide a mechanism that can more finely estimate positions of devices.

### Solution to Problem

To solve the above described problem, according to an aspect of the present invention, there is provided a control device comprising a control section configured to obtain one or more distance measurement values, and estimate a relative position of a position changeable type communication device with respect to a target space based on the one or more distance measurement values, the one or more distance measurement values being obtained when one or more position fixed type communication devices and the position changeable type communication device perform wireless communication, and indicating a distance between each of the one or more position fixed type communication devices and the position changeable type communication device, the one or more position fixed type communication devices being communication devices whose relative positions with respect to the target space that is a space partitioned by an object are fixed, and the position changeable type communication device being a communication device whose relative position with respect to the target space is changeable.

To solve the above described problem, according to another aspect of the present invention, there is provided a control system comprising: one or more position fixed type communication devices that are communication devices whose relative positions with respect to a target space that is a space partitioned by an object are fixed, and a control device configured to obtain one or more distance measurement values, and estimate the relative position of a position changeable type communication device with respect to the target space based on the one or more distance measurement values, the one or more distance measurement values being obtained when each of the one or more position fixed type communication devices and the position changeable type communication device perform wireless communication, and indicating a distance between each of the one or more position fixed type communication devices and the position changeable type communication device, and the position changeable type communication device being a communication device whose relative position with respect to the target space is changeable.

To solve the above described problem, according to another aspect of the present invention, there is provided a program causing a computer to function as a control section configured to obtain one or more distance measurement values, and estimate a relative position of a position changeable type communication device with respect to a target space based on the one or more distance measurement values, the one or more distance measurement values being obtained when one or more position fixed type communication devices and the position changeable type communication device perform wireless communication, and indicating a distance between each of the one or more position fixed type communication devices and the position changeable type communication device, the one or more position fixed type communication devices being communication devices whose relative positions with respect to the target space that is a space partitioned by an object are fixed, and the position changeable type communication device being a communication device whose relative position with respect to the target space is changeable.

### Advantageous Effects of Invention

As described above, the present invention provides a mechanism that can more finely estimate positions of devices.

### BRIEF DESCRIPTION OF DRAWINGS

FIG. 1 is a diagram illustrating an example of a configuration of a system according to an embodiment of the present invention.

FIG. 2 is a sequence diagram illustrating an example of a flow of a distance measurement process executed by the system according to the present embodiment.

FIG. 3 is a view illustrating an example of arrangement of communication devices according to the present embodiment.

FIG. 4 is a view for explaining position estimation that is based on a first condition according to the present embodiment.

FIG. 5 is a view for explaining position estimation that is based on a second condition according to the present embodiment.

FIG. 6 is a view for explaining position estimation that is based on the first condition and the second condition according to the present embodiment.

FIG. 7 is a sequence diagram illustrating an example of a flow of a position estimation process executed by the system according to the present embodiment.

### DESCRIPTION OF EMBODIMENTS

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

Furthermore, elements employing substantial identical functional configurations in the description and the drawings are distinguished by assigning different alphabets to tails of identical reference numerals in some cases. For example, a plurality of elements employing substantially identical functional configurations are distinguished as communication devices 210A, 210B, and 210C when necessary. In this regard, in a case where each of a plurality of elements employing the substantially identical functional configurations does not need to be distinguished in particular, each of a plurality of elements is assigned only an identical reference numeral. For example, in a case where the communication devices 210A, 210B, and 210C do not need to be distinguished in particular, the communication devices 210A, 210B, and 210C will be referred to simply as a communication device 210.

### 1. Configuration Example

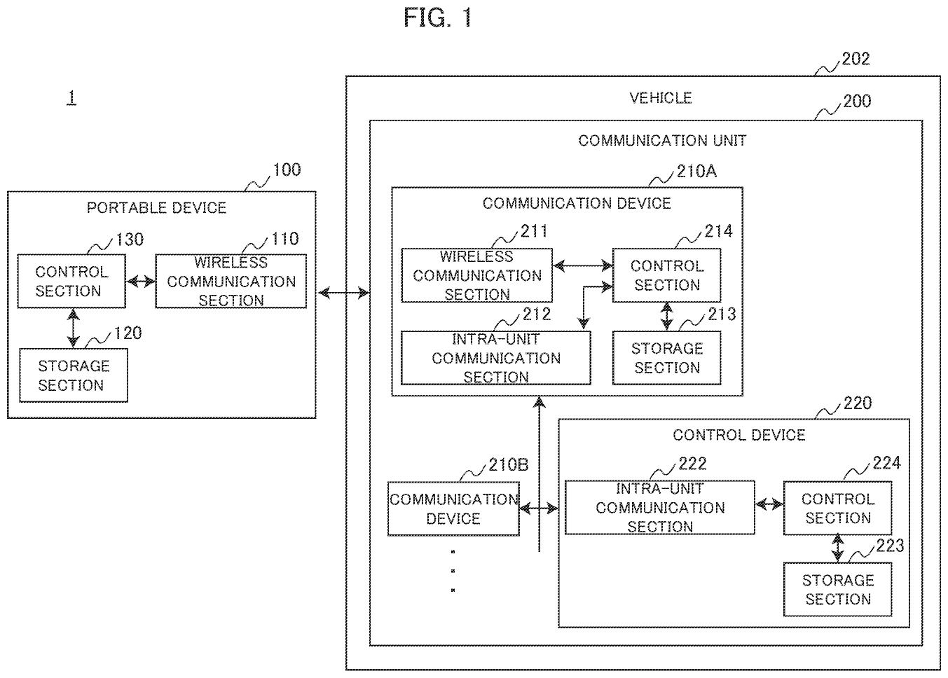

FIG. 1 is a diagram illustrating an example of a configuration of a system 1 according to an embodiment of the present invention. As illustrated in FIG. 1, the system 1 according to the present embodiment includes a portable device 100 and a communication unit 200. The communication unit 200 according to the present embodiment is mounted on a vehicle 202. The vehicle 202 is an example of a movable body. Furthermore, the vehicle 202 is an example of a user's use target.

A device of an authenticatee side and a device of an authenticator side are involved in the present invention. The portable device 100 is an example of the device of the authenticatee side. The communication unit 200 is an example of the device of the authenticator side.

When the user (e.g., a driver of the vehicle 202) approaches the vehicle 202 carrying the portable device 100, the portable device 100 and the communication unit 200 perform wireless communication for authentication. Furthermore, when authentication succeeds, a door lock of the vehicle 202 is unlocked or an engine is started, and then the vehicle 202 becomes usable for the user. The system 1 is also referred to as a smart entry system. Hereinafter, each component will be described in order.

(1) Portable Device 100

The portable device 100 is an example of a device that the user of the movable body carries to use. The portable device 100 is configured as an arbitrary device carried by the user. The arbitrary device includes, for example, an electronic key, a smartphone, and a wearable terminal.

As illustrated in FIG. 1, the portable device 100 includes a wireless communication section 110, a storage section 120, and a control section 130.

The wireless communication section 110 has a function of performing communication that conforms to predetermined wireless communication standards with the communication unit 200. The wireless communication section 110 performs wireless communication with each of the plurality of communication devices 210 included in the communication unit 200. The wireless communication section 110 is configured as, for example, a communication interface that can perform communication that conforms to the predetermined wireless communication standards.

According to, for example, the predetermined wireless communication standards, a signal that uses an Ultra-Wide Band (UWB) may be used. A signal of an impulse system that uses the UWB has characteristics that it is possible to precisely measure a distance. That is, the signal of the impulse system that uses the UWB makes it possible to precisely measure a radio wave propagation time by using a radio wave of a very short pulse width equal to or less than nano seconds, and makes it possible to precisely measure a distance based on the propagation time. In this regard, distance measurement refers to measuring a distance between devices that transmit and receive signals.

Hereinafter, it is assumed that the wireless communication section 110 transmits and receives signals that use the UWB.

The storage section 120 has a function of storing various pieces of information for an operation of the portable device 100. For example, the storage section 120 stores, for example, programs for operations of the portable device 100, and an Identifier (ID), a password and an authentication algorithm for authentication. The storage section 120 is configured as, for example, a storage medium such as a flash memory, and a processing device that executes recording and playback with respect to the storage medium.

The control section 130 has a function of controlling all operations of the portable device 100. In an example, the control section 130 controls the wireless communication section 110, and communicates with the communication unit 200. Furthermore, the control section 130 reads information from the storage section 120, and writes the information in the storage section 120. The control section 130 is configured as, for example, an electronic circuit such as a Central Processing Unit (CPU) and a microprocessor.

(2) Communication Unit 200

The communication unit 200 is provided in association with the vehicle 202. In this regard, the communication unit 200 is mounted on the vehicle 202.

The communication unit 200 includes the one or more communication devices 210. In the example illustrated in FIG. 1, the communication unit 200 includes the plurality of communication devices 210 (such as 210A and 210B) and a control device 220. In addition, the communication unit 200 may include the three or more communication devices 210. Furthermore, as illustrated in FIG. 1, the communication unit 200 includes the control device 220. The communication unit 200 is an example of a control system.

Communication Device 210

The communication device 210 is a device that performs wireless communication with the portable device 100.

As illustrated in FIG. 1, the communication device 210A includes a wireless communication section 211, an intra-unit communication section 212, a storage section 213, and a control section 214. In this regard, the other communication devices 210 such as the communication device 210B also include components similar to those of the communication device 210A.

The wireless communication section 211 has a function of performing communication that conforms to predetermined wireless communication standards with the portable device 100. The wireless communication section 211 is configured as, for example, a communication interface that can perform communication that conforms to the predetermined wireless communication standards. Hereinafter, it is assumed that the wireless communication section 211 transmits and receives a signal that uses the UWB.

The intra-unit communication section 212 has a function of performing communication with the other devices included in the communication unit 200. In an example, the intra-unit communication section 212 communicates with the control device 220. In another example, the intra-unit communication section 212 communicates with the other communication devices 210. The intra-unit communication section 212 is configured as, for example, a communication interface that can perform communication that conforms to standards of an arbitrary in-vehicle network such as a Local Interconnect Network (LIN) or a Controller Area Network (CAN).

The storage section 213 has a function of storing various pieces of information for operations of the communication device 210. For example, the storage section 213 stores, for example, programs for operations of the communication device 210, and an Identifier (ID), a password and an authentication algorithm for authentication. The storage section 213 is configured as, for example, a storage medium such as a flash memory, and a processing device that executes recording and playback with respect to the storage medium.

The control section 214 has a function of controlling operations of the communication device 210. In an example, the control section 214 controls the wireless communication section 211, and communicates with the portable device 100. In another example, the control section 214 controls the intra-unit communication section 212, and communicates with the other devices included in the communication unit 200. In still another example, the control section 214 reads information from the storage section 213, and writes the information in the storage section 213. The control section 214 is configured as, for example, an Electronic Control Unit (ECU).

Control Device 220

The control device 220 is a device that executes communication with the plurality of communication devices 210.

As illustrated in FIG. 1, the control device 220 includes an intra-unit communication section 222, a storage section 223, and a control section 224.

The intra-unit communication section 222 has a function of performing communication with the other devices included in the communication unit 200. In an example, the intra-unit communication section 222 communicates with the communication device 210. The intra-unit communication section 222 is configured as, for example, a communication interface that can perform communication that conforms to standards of an arbitrary in-vehicle network such as a Local Interconnect Network (LIN) or a Controller Area Network (CAN).

The storage section 223 has a function of storing various pieces of information for operations of the control device 220. For example, the storage section 223 stores, for example, programs for operations of the control device 220, and an Identifier (ID), a password and an authentication algorithm for authentication. The storage section 213 is configured as, for example, a storage medium such as a flash memory, and a processing device that executes recording and playback with respect to the storage medium.

The control section 224 has a function of controlling operations of the control device 220. In one example, the control section 224 controls the intra-unit communication section 222, and communicates with the other devices included in the communication unit 200. In another example, the control section 224 reads information from the storage section 223, and writes the information in the storage section 223. The control section 224 is configured as, for example, an Electronic Control Unit (ECU).

Above all, the control section 224 executes a process that is based on information obtained by wireless communication between each of the plurality of communication devices 210 and the portable device 100.

An example of the process is an authentication process of authenticating the portable device 100. Another example of the process is a process of controlling the door lock such as locking and unlocking of the door lock of the vehicle 202. Still another example of the process is a process of controlling a power source such as start/stop of the engine of the vehicle 202. In addition, the power source included in the vehicle 202 may be, for example, a motor in addition to the engine.

### 2. Technical Features

(1) Distance Measurement Process

The portable device 100 and the communication unit 200 perform a distance measurement process. The distance measurement process is a process of measuring a distance between the portable device 100 and the communication unit 200. The distance measured by the distance measurement process is also referred to as a distance measurement value below.

During the distance measurement process, a signal may be wirelessly transmitted and received.

An example of the signal transmitted and received during the distance measurement process is a distance measurement signal. The distance measurement signal is a signal that is transmitted and received to measure a distance between devices. The distance measurement signal is also a signal that is a measurement target. For example, a time taken to transmit and receive the distance measurement signal is measured. Typically, the distance measurement signal includes a frame format that does not include a payload part in which data is stored. The distance measurement signal may naturally include a frame format that includes a payload part in which data is stored.

During the distance measurement process, a plurality of distance measurement signals may be transmitted and received between devices. The distance measurement signal transmitted from the one device to the other device among the plurality of distance measurement signals is also referred to as a first distance measurement signal. Furthermore, the distance measurement signal transmitted from the device that has received the first distance measurement signal to the device that has transmitted the first distance measurement signal is also referred to as a second distance measurement signal.

Another example of the signal transmitted and received during the distance measurement process is a data signal. The data signal is a signal in which data is stored to transport. The data signal includes a frame format that includes a payload part in which data is stored.

Transmitting and receiving a signal during the distance measurement process is also referred to as distance measurement communication below. In the present embodiment, the portable device 100 and each of the plurality of communication devices 210 perform distance measurement communication.

During the distance measurement process, a distance between the portable device 100 and the communication device 210 that have performed the distance measurement communication is measured as a distance between the portable device 100 and the communication unit 200.

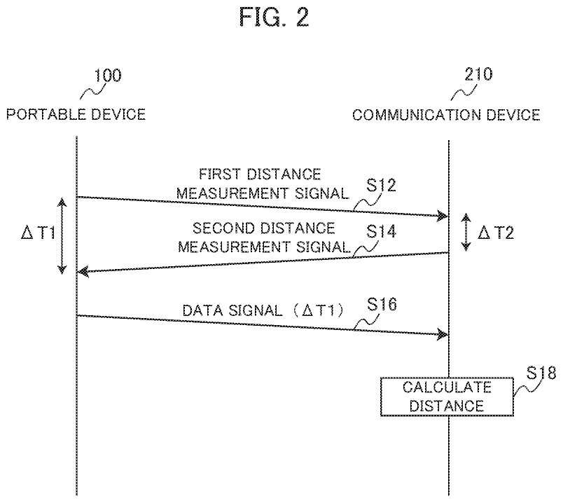

An example of the distance measurement process will be described with reference to FIG. 2.

FIG. 2 is a sequence diagram illustrating an example of a flow of the distance measurement process executed by the system 1 according to the present embodiment. The portable device 100 and the communication device 210 are involved in this sequence.

As illustrated in FIG. 2, the wireless communication section 110 of the portable device 100 first transmits the first distance measurement signal (step S12). The first distance measurement signal is transmitted as a signal that uses the UWB.

When receiving the first distance measurement signal from the portable device 100, the wireless communication section 211 of the communication device 210 transmits the second distance measurement signal as a response to the first distance measurement signal (step S14). The second distance measurement signal is transmitted as a signal that uses the UWB.

When the wireless communication section 110 receives the second distance measurement signal, the control section 130 of the portable device 100 measures a time ΔT1 from a transmission time of the first distance measurement signal to a reception time of the second distance measurement signal. Next, the wireless communication section 110 of the portable device 100 transmits a data signal that includes information obtained by encrypting information that indicates measured ΔT1 (step S16). The data signal is transmitted as a signal that uses the UWB.

On the other hand, the control section 214 of the communication device 210 measures a time ΔT2 from a reception time of the first distance measurement signal to a transmission time of the second distance measurement signal. Furthermore, when the wireless communication section 211 receives the data signal from the portable device 100, the control section 214 of the communication device 210 obtains a distance measurement value that indicates the distance between the portable device 100 and the communication device 210 based on ΔT1 indicated by the received data signal and measured ΔT2 (step S18). For example, the communication device 210 first calculates a propagation time by dividing ΔT1−ΔT2 by 2. The propagation time described herein is a time taken for one-way signal transmission/reception between the portable device 100 and the communication device 210. Furthermore, the communication device 210 calculates the distance measurement value that indicates the distance between the portable device 100 and the communication device 210 by multiplying the propagation time with a signal speed.

In this regard, during distance measurement communication, a signal that uses the UWB is desirably transmitted and received. At least the distance measurement signal is desirably transmitted and received as a signal that uses the UWB. According to this configuration, it is possible to precisely perform distance measurement as described above on the UWB.

In recent years, it is studied to mount on a vehicle a wireless communication function that can transmit and receive signals of Ultra-High Frequency (UHF) and Low Frequency (LF) bands or a signal of Bluetooth Low Energy (BLE and registered trademark). Furthermore, it is studied to measure a distance between a vehicle and another device based on a radio field strength on a reception side of a wirelessly transmitted signal.

However, it is less probable that a function of transmitting and receiving the signal of the UHF band and the signal of the LF band is mounted on smartphones. On the other hand, it is highly probable that a function of transmitting and receiving a signal that uses the UWB is mounted on smartphones. The technology according to the present embodiment performs distance measurement communication that uses the UWB, and therefore it can be said that it is highly probable that the technology is mounted on smartphones.

Furthermore, BLE has a relatively great variation of the radio field strength, and therefore provides low distance measurement accuracy. In this regard, the technology according to the present embodiment performs distance measurement that is based on a propagation time by using a signal that uses the UWB, so that it is possible to exhibit high distance measurement accuracy compared to distance measurement that uses a signal using BLE and is based on a radio field strength.

(2) Arrangement of Communication Devices

The communication device 210 is mounted on the vehicle 202. The communication device 210 is an example of a position fixed type communication device. The position fixed type communication device is a communication device whose relative position with respect to a target space that is a space partitioned by an object is fixed.

A vehicle interior of the vehicle 202 is an example of the target space. In this regard, the vehicle interior is a space that is provided in the vehicle 202 for the user to get on the vehicle 202. In a case where the target space is the vehicle interior, an example of the object that partitions the target space is a component that makes up an outermost shell of the vehicle 202. The component that makes up the outermost shell of the vehicle 202 is a layer that is the most distant layer seen from the vehicle interior among components that make up the vehicle interior. An example of the component that makes up the outermost shell of the vehicle 202 is a steel plate that makes up a body of the vehicle 202, a steel plate that makes up doors, and glass windows that are fitted to the doors. Note that interior parts are applied using a resin to the vehicle interior side of the steel plate that makes up the body and the steel plate that makes up the doors in some cases. These interior parts are also included in the vehicle interior.

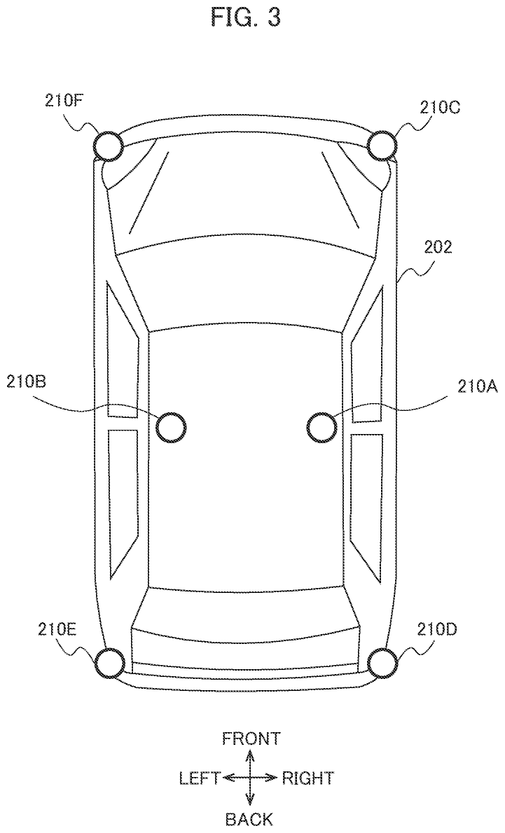

FIG. 3 is a view illustrating an example of arrangement of the communication devices 210 according to the present embodiment. In the example illustrated in FIG. 3, the vehicle 202 is provided with communication devices 210A to 210F. As illustrated in FIG. 3, a traveling direction of the vehicle 202 is also referred to as a forward direction. A direction opposite to the traveling direction of the vehicle 202 is also referred to as a backward direction. Furthermore, a direction perpendicular to the traveling direction of the vehicle 202 is also referred to as a right direction and a left direction.

The position fixed type communication device includes one or more first position fixed type communication devices that are position fixed type communication devices arranged inside the target space. In the example illustrated in FIG. 3, the communication device 210A and the communication device 210B are examples of the first position fixed type communication devices. That is, the communication device 210A and the communication device 210B are arranged inside the vehicle interior of the vehicle 202. According to this configuration, it is possible to suppress that it is estimated by mistake that the portable device 100 is located inside the vehicle interior even though the portable device 100 is actually located outside the vehicle interior during position estimation that is based on a first condition described below.

More specifically, the first position fixed type communication devices may be arranged between an end part on the traveling direction side of the vehicle 202 and an end part on the opposite direction side to the traveling direction of the vehicle 202. In the example illustrated in FIG. 3, the communication device 210A and the communication device 210B are arranged at center parts in a front-back direction of the vehicle 202. According to this configuration, it is possible to appropriately set a first virtual space during the position estimation that is based on the first condition described below.

The position fixed type communication device includes one or more second position fixed type communication devices that are the position fixed type communication devices arranged outside the target space. In the example illustrated in FIG. 3, the communication device 210C to the communication device 210F are examples of the second position fixed type devices. According to this configuration, it is possible to suppress that it is estimated by mistake that the portable device 100 is located outside the vehicle interior even though the portable device 100 is actually located inside the vehicle interior during position estimation that is based on a second condition described below.

More specifically, the second position fixed type communication devices may be arranged at each of end parts on the traveling direction side of the vehicle 202 and end parts on the opposite direction side to the traveling direction of the vehicle 202. In the example illustrated in FIG. 3, the communication device 210C and the communication device 210F are arranged at the end parts in the forward direction of the vehicle 202. On the other hand, the communication device 210D and the communication device 210E are arranged at end parts in the backward direction of the vehicle 202. In an example, the communication device 210C to the communication device 210F may be arranged at bumpers of the vehicle 202. Note that the bumper is a buffer device that buffers an impact and vibration caused when the vehicle 202 contacts other objects. According to this configuration, it is possible to appropriately set a second virtual space during the position estimation that is based on the second condition described below.

Furthermore, the second position fixed type communication devices may be arranged at end parts in the direction perpendicular to the traveling direction of the vehicle 202. In the example illustrated in FIG. 3, the communication device 210C and the communication device 210D are arranged at the end parts in the right direction of the vehicle 202. On the other hand, the communication device 210E and the communication device 210F are arranged at the end parts in the left direction of the vehicle 202. According to this configuration, it is possible to appropriately set the second virtual space during the position estimation that is based on the second condition described below.

The arrangement of the communication unit 200 that is the example of the position fixed type communication device has been described. On the other hand, the portable device 100 is an example of the position changeable type communication device. The position changeable type communication device is a communication device whose relative position with respect to the target space is changeable. The portable device 100 is carried by the user, and moves as the user moves. For example, the portable device 100 may be located inside the vehicle interior or located outside the vehicle interior.

(3) Position Estimation Based on Distance Measurement Value

The control device 220 obtains one or more distance measurement values that are obtained when each of the one or more communication devices 210 and the portable device 100 perform wireless communication, and indicate a distance between each of the one or more communication devices 210 and the portable device 100. The wireless communication described herein is distance measurement communication. Each of the one or more communication devices 210 obtains the distance measurement value by performing a process of measuring a distance to the portable device 100, and transmits the distance measurement value to the control device 220. Consequently, the control device 220 can obtain the distance measurement value obtained by each of the one or more communication devices 210.

Furthermore, the control device 220 estimates the relative position of the position changeable type communication device with respect to the target space based on the one or more distance measurement values. For example, the control device 220 estimates the relative position of the portable device 100 with respect to the vehicle interior. According to this configuration, it is possible to estimate the relative position of the portable device 100 with respect to the vehicle interior as a position of the portable device 100. Consequently, it is possible to more finely estimate the position of the portable device 100 compared to the simple distance measurement values.

The control device 220 may estimate whether or not the position changeable type communication device is located inside the target space to estimate the relative position of position changeable type communication device with respect to the target space. For example, the control device 220 estimates whether or not whether or not the portable device 100 is located inside the vehicle interior. According to this configuration, based on the estimation result, the control device 220 can appropriately execute a process that needs to be executed based on a condition that the portable device 100 is located inside the vehicle interior. An example of the process that needs to be executed based on the condition that the portable device 100 is located inside the vehicle interior is to permit start of the engine.

The control device 220 may estimate whether or not the position changeable type communication device is located outside the target space to estimate the relative position of the position changeable type communication device with respect to the target space. For example, the control device 220 estimates whether or not the portable device 100 is located outside the vehicle interior. According to this configuration, based on the estimation result, the control device 220 can appropriately execute the process that needs to be executed based on a condition that the portable device 100 is located outside the vehicle interior. An example of the process that needs to be executed based on the condition that the portable device 100 is located outside the vehicle interior is to park the vehicle by a remote operation.

Position Estimation Based on First Condition

The first condition is a condition that the distance measurement value satisfies when the position changeable type communication device is located inside the first virtual space that is the virtual space at least part of which overlaps the target space. That is, when the portable device 100 is located inside the first virtual space, the first condition is satisfied. On the other hand, when the portable device 100 is located outside the first virtual space, the first condition is not satisfied.

The control device 220 estimates whether or not the position changeable type communication device is located inside the target space by deciding whether or not the distance measurement values satisfy the first condition. For example, the control device 220 decides whether or not the distance measurement value satisfies the first condition. Furthermore, the control device 220 estimates that the portable device 100 is located inside the vehicle interior when the first condition is satisfied. On the other hand, the control device 220 estimates that the portable device 100 is located outside the vehicle interior when the first condition is not satisfied. According to this configuration, the control device 220 can estimate whether or not the portable device 100 is located inside the vehicle interior based on the distance measurement value.

The control device 220 decides whether or not the one or more distance measurement values that indicate the distance between each of the one or more first position fixed type communication devices and the position changeable type communication device satisfy the first condition to decide whether or not the distance measurement values satisfy the first condition. For example, the control device 220 decides whether or not the distance measurement value obtained by the communication device 210A and the distance measurement value obtained by the communication device 210B satisfy the first condition. According to this configuration, the control device 220 can decide whether or not the first condition is satisfied based on the distance measurement value of the first position fixed type communication device.

The first condition is that a sum of the one or more distance measurement values that indicate the distance between each of the one or more first position fixed type communication devices and the position changeable type communication device is equal to or less than a first threshold. That is, the first virtual space is a space in which, when the position changeable type communication device is located inside the first virtual space, the sum of the one or more distance measurement values that indicate the distance between each of the one or more first position fixed type communication devices and the position changeable type communication device is equal to or less than the first threshold. The first condition is expressed by, for example, a following equation.

[Mathematical 1]

L_{A}+L_{B}≤Th₁ (1)

In this regard, LA represents a distance measurement value obtained by the communication device 210A. LB represents a distance measurement value obtained by the communication device 210A. Th1 represents the first threshold.

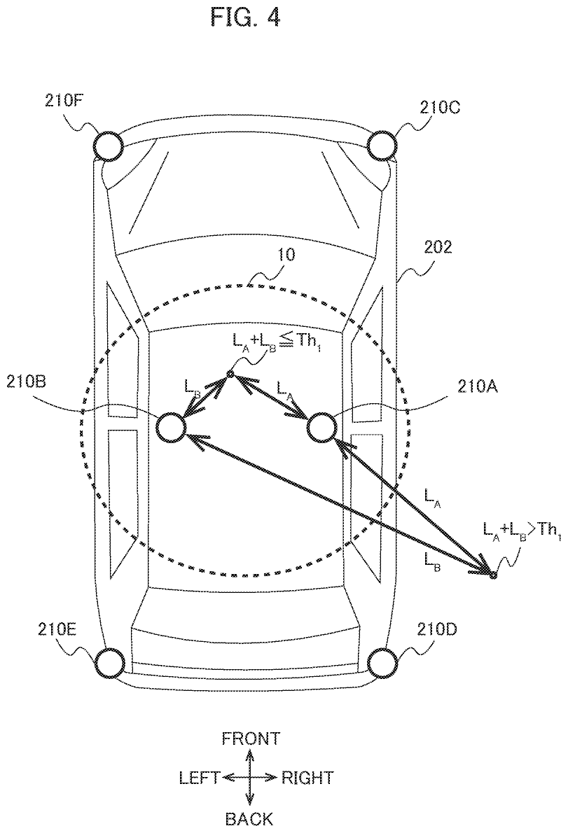

The first condition indicated in above equation (1) will be more specifically described with reference to FIG. 4. FIG. 4 is a view for explaining position estimation that is based on the first condition according to the present embodiment.

The control device 220 decides whether or not the sum of the one or more distance measurement values that indicate the distance between each of the one or more first position fixed type communication devices and the position changeable type communication device is equal to or less than the first threshold to decide whether or not the distance measurement values satisfy the first condition. For example, the control device 220 decides whether or not the sum of the distance measurement value LA obtained by the communication device 210A and the distance measurement value LB obtained by the communication device 210B is equal to or less than the first threshold Th1 as indicated in above equation (1).

When the portable device 100 is located inside a first virtual space 10 as illustrated in FIG. 4, the sum of the distance measurement value LA obtained by the communication device 210A and the distance measurement value LB obtained by the communication device 210B is equal to or less than the first threshold Th1. Hence, when the sum of the distance measurement value LA and the distance measurement value LB is equal to or less than the first threshold Th1, the control device 220 decides that the first condition is satisfied. That is, the control device 220 estimates that the portable device 100 is located inside the first virtual space. Furthermore, the control device 220 estimates the portable device 100 is located inside the vehicle interior.

On the other hand, when the portable device 100 is located outside the first virtual space 10 as illustrated in FIG. 4, the sum of the distance measurement value LA obtained by the communication device 210A and the distance measurement value LB obtained by the communication device 210B exceeds the first threshold Th1.

Hence, when the sum of the distance measurement value LA and the distance measurement value LB exceeds the first threshold Th1, the control device 220 decides that the first condition is not satisfied. That is, the control device 220 estimates that the portable device 100 is located outside the first virtual space. Furthermore, the control device 220 estimates that the portable device 100 is not located inside the vehicle interior (that is, located outside the vehicle interior).

According to this configuration, the control device 220 can estimate whether or not the portable device 100 is located inside the vehicle interior based on the sum of the distance measurement values of the first position fixed type communication devices.

In this regard, the communication device 210A and the communication device 210B are arranged inside the vehicle interior (that is, inside the target space). Hence, when the portable device 100 is located outside the vehicle interior, the distance measurement value of each of the communication device 210A and the communication device 210B becomes longer than an actual distance due to an influence of an obstacle such as the door. Hence, when the portable device 100 is located outside the vehicle interior, the first condition indicated by above equation (1) is hardly satisfied. Consequently, in a case where the first virtual space goes beyond the vehicle interior and includes a space outside the vehicle interior, too, even when the portable device 100 is located at this extended part, it is possible to suppress that it is estimated by mistake that the portable device 100 is located inside the vehicle interior.

Furthermore, as illustrated in FIG. 4, the first virtual space 10 that matches above equation (1) is formed in an elliptical shape whose center is the communication device 210A and the communication device 210B. Furthermore, the communication device 210A and the communication device 210B are arranged between the end part on the traveling direction side of the vehicle 202 and the end part on the opposite direction side to the traveling direction of the vehicle 202. Consequently, it is possible to appropriately set the first virtual space 10 as a space that is provided at the center in the front-back direction of the vehicle 202 and includes the vehicle interior.

Position Estimation Based on Second Condition

The second condition is a condition that a distance measurement value satisfies when the position changeable type communication device is located outside the second virtual space that is a virtual space at least part of which overlaps a non-target space that is a space outside the target space. That is, when the portable device 100 is located outside the second virtual space, the second condition is satisfied. On the other hand, when the portable device 100 is located inside the second virtual space, the second condition is not satisfied.

The non-target space is a space that is outside the vehicle interior of the vehicle 202. Above all, a space (also referred to as a door vicinity space below) in the vicinity of the door outside the vehicle interior of the vehicle 202 is an example of the non-target space.

The control device 220 estimates whether or not the position changeable type communication device is located in the non-target space by deciding whether or not the distance measurement values satisfy the second condition. Furthermore, when estimating that the position changeable type communication device is located in the non-target space, the control device 220 estimates that the position changeable type communication device is not located in the target space. When, for example, the second condition is not satisfied, the control device 220 estimate that the portable device 100 is located in the door vicinity space. Furthermore, the control device 220 estimates that the portable device 100 is not located inside the vehicle interior. On the other hand, when the second condition is satisfied, the control device 220 estimate that the portable device 100 is not located in the door vicinity space. Furthermore, the control device 220 estimates that the portable device 100 may be located inside the vehicle interior. According to this configuration, the control device 220 can estimate whether or not the portable device 100 is located in the door vicinity space based on the second virtual space. As a result, the control device 220 can estimate that the portable device 100 is not located inside the vehicle interior or the portable device 100 may be located inside the vehicle interior.

The control device 220 decides whether or not the one or more distance measurement values that indicate the distance between each of the one or more second position fixed type communication devices and the position changeable type communication device satisfy the second condition to decide whether or not the distance measurement values satisfy the second condition. For example, the control device 220 decides whether or not the distance measurement value obtained by each of the communication device 210C to the communication device 210F satisfies the second condition. According to this configuration, the control device 220 can decide whether or not the second condition is satisfied based on the distance measurement values of the second position fixed type communication devices.

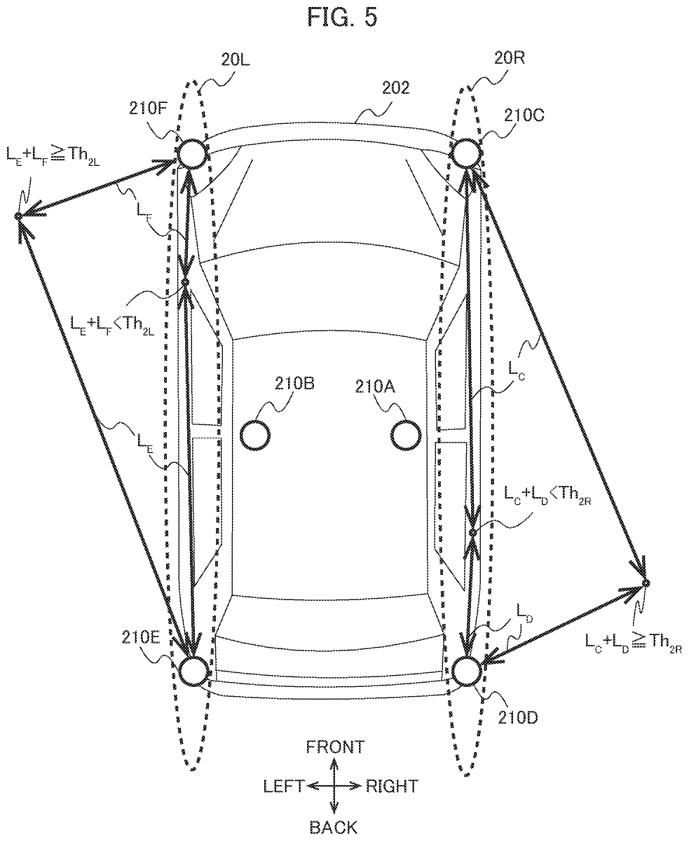

Position estimation that is based on the second condition will be specifically described below with reference to FIG. 5.

FIG. 5 is a view for explaining the position estimation that is based on the second condition according to the present embodiment. As illustrated in FIG. 5, a second virtual space 20R is set to a right side of the vehicle 202. The second virtual space 20R corresponds to the communication device 210C and the communication device 210D arranged on the right side of the vehicle 202. A second virtual space 20L is set to a left side of the vehicle 202. The second virtual space 20L corresponds to the communication device 210E and the communication device 210F arranged on the left side of the vehicle 202. At least part of each of the second virtual space 20R and the second virtual space 20L overlaps the door vicinity space that is the non-target space.

The second condition is that the sum of the one or more distance measurement values that indicate the distance between each of the one or more second position fixed type communication devices and the position changeable type communication device is equal to or more than a second threshold. That is, the second virtual space is a space in which, when the position changeable type communication device is located outside the second virtual space, the sum of the one or more distance measurement values that indicate the distance between each of the one or more second position fixed type communication devices and the position changeable type communication device is equal to or more than the second threshold. Note that, as illustrated in FIG. 5, in a case where the plurality of second virtual spaces 20 are set, the second condition can be set to each of the plurality of set second virtual spaces.

The second condition set to the second virtual space 20R is expressed by, for example, a following equation.

[Mathematical 2]

L_{C}+L_{D}≥Th_{2R} (2)

LC represents a distance measurement value that is obtained by the communication device 210C. LD represents a distance measurement value that is obtained by the communication device 210D. Th2R represents the second threshold that is associated with the second virtual space 20R.

The control device 220 decides whether or not the sum of the one or more distance measurement values that indicate the distance between each of the one or more second position fixed type communication devices and the position changeable type communication device is equal to or more than the second threshold to decide whether or not the distance measurement values satisfy the second condition. For example, the control device 220 decides whether or not the sum of the distance measurement value LC obtained by the communication device 210C and the distance measurement value LD obtained by the communication device 210D is equal to or more than the second threshold TH2R as indicated in above equation (2).

When the portable device 100 is located inside the second virtual space 20R as illustrated in FIG. 5, the sum of the distance measurement value LC obtained by the communication device 210C and the distance measurement value LD obtained by the communication device 210D is less than the second threshold TH2R. Hence, when the sum of the distance measurement value LC and the distance measurement value LD is less than the second threshold TH2R, the control device 220 decides that the second condition is not satisfied. Furthermore, when deciding that the second condition is not satisfied, the control device 220 estimates that the portable device 100 is located in the door vicinity space. That is, the control device 220 estimates that the portable device 100 is located outside the vehicle interior.

On the other hand, when the portable device 100 is located outside the second virtual space 20R as illustrated in FIG. 5, the sum of the distance measurement value LC obtained by the communication device 210C and the distance measurement value LD obtained by the communication device 210D is equal to or more than the second threshold TH2R. Hence, when the sum of the distance measurement value LC and the distance measurement value LD is equal to or more than the second threshold TH2R, the control device 220 decides that the second condition is satisfied. Furthermore, when deciding that the second condition is satisfied, the control device 220 estimates that the portable device 100 is not located in the door vicinity space. That is, the control device 220 estimates that the portable device 100 may be located inside the vehicle interior.

According to this configuration, the control device 220 can estimate whether or not the portable device 100 is located in the door vicinity space based on the sum of the distance measurement values of the second position fixed type communication devices, and, as a result, estimate whether or not the portable device 100 is located outside the vehicle interior or may be located inside the vehicle interior.

In this regard, the communication device 210C and the communication device 210D are arranged outside the vehicle interior. Therefore, when the portable device 100 is located inside the vehicle interior, the distance measurement value of each of the communication device 210C and the communication device 210D becomes longer than an actual distance due to an influence of an obstacle such as the door. Hence, when the portable device 100 is located inside the vehicle interior, the second condition indicated in above equation (2) is readily satisfied. Consequently, in a case where the second virtual space goes beyond the door and includes a space inside the vehicle interior, too, even when the portable device 100 is located at this extended part, it is possible to suppress that it is estimated by mistake that the portable device 100 is located outside the vehicle interior.

Furthermore, as illustrated in FIG. 5, the second virtual space 20R that matches above equation (2) is formed in an elliptical shape whose center is the communication device 210C and the communication device 210D. Furthermore, the communication device 210C and the communication device 210D are arranged at each of the end part on the traveling direction side of the vehicle 202 and the end part on the opposite direction side to the traveling direction of the vehicle 202. Hence, as illustrated in FIG. 5, it is possible to finely set the second virtual space 20R in the left-right direction, so that it is possible to prevent the space inside the vehicle interior from being included in the second virtual space as much as possible. From another viewpoint, the communication device 210C and the communication device 210D are arranged at end parts in a direction (right direction) perpendicular to the traveling direction of the vehicle 202. Consequently, as illustrated in FIG. 5, the door vicinity space on the right side that is the non-target space can be included in the second virtual space. Consequently, it is possible to appropriately set the second virtual space 20 that is the space that does not include the space inside the vehicle interior as much as possible and includes the door vicinity space.

The second condition set to the second virtual space 20L is expressed by, for example, a following equation.

[Mathematical 3]

L_{E}+L_{F}≥Th_{2L} (3)

LE represents a distance measurement value that is obtained by the communication device 210E. LF represents a distance measurement value that is obtained by the communication device 210F. Th2L represents the second threshold that is associated with the second virtual space 20L.

The control device 220 performs a process similar to the process related to the second condition set to the above-described second virtual space 20R as a process related to the second condition set to the second virtual space 20L.

Position Estimation Based on First Condition and Second Condition

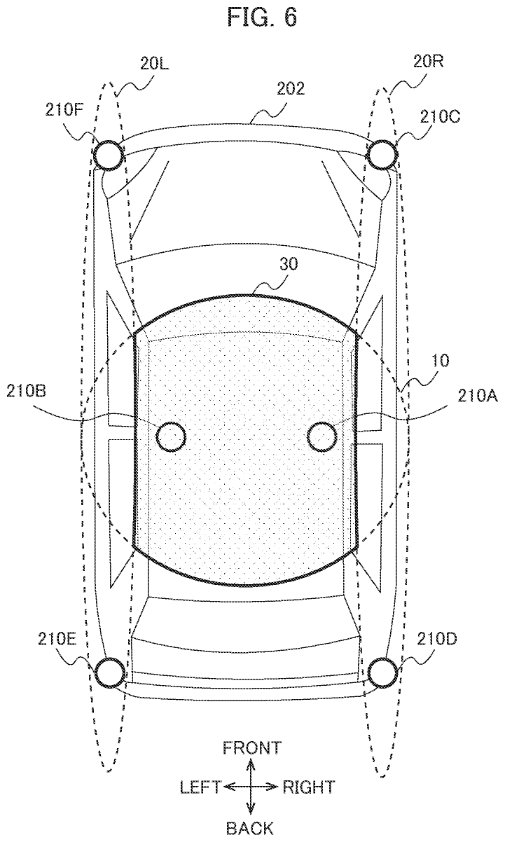

When both of the first condition and the second condition are satisfied, the control device 220 estimates that the position changeable type communication device is located inside the target space. When, for example, both of the first condition and the second condition are satisfied, the control device 220 estimates that the portable device 100 is located inside the vehicle interior. This point will be described with reference to FIG. 6.

FIG. 6 is a view for explaining position estimation that is based on the first condition and the second condition according to the present embodiment. A third virtual space 30 illustrated in FIG. 6 is a space that is inside the first virtual space 10 and is outside the second virtual space 20. When the portable device 100 is located inside the first virtual space 10, the first condition is satisfied. On the other hand, when the portable device 100 is located outside the second virtual space 20, the second condition is satisfied. Hence, when the portable device 100 is located inside the third virtual space 30, both of the first condition and the second condition are satisfied.

Hence, when both of the first condition and the second condition are satisfied, the control device 220 estimates that the portable device 100 is located inside the third virtual space 30. Furthermore, the control device 220 estimates that the portable device 100 is located inside the vehicle interior. On the other hand, when one of the first condition and the second condition is not satisfied or is satisfied, the control device 220 estimates that the portable device 100 is located outside the third virtual space 30. Furthermore, the control device 220 estimates that the portable device 100 is located outside the vehicle interior.

According to this configuration, it is possible to estimate whether or not the portable device 100 is located inside the vehicle interior based on whether or not the portable device 100 is located inside the third virtual space that is a space of the first virtual space that does not overlap the second virtual space. Even when the first virtual space goes beyond the vehicle interior and includes a space outside the vehicle interior, too, it is possible to exclude this extended part by the second virtual space. Consequently, it is possible to reduce that it is decided by mistake that the portable device 100 is located inside the vehicle interior even though the portable device 100 is located outside the vehicle interior (e.g., door vicinity space).

Note that, regarding the second condition, the control device 220 may decide which one of above equations (2) and (3) to use according to which one of the left and the right of the vehicle 202 the portable device 100 is located on. When, for example, the distance measurement value LA obtained by the communication device 210A is equal to or less than the distance measurement value LB obtained by the communication device 210B, the control device 220 decides that the portable device 100 is located on the right side of the vehicle 202. In this case, the control device 220 decides based on equation (2) whether or not the second condition is satisfied. On the other hand, when the distance measurement value LA obtained by the communication device 210A exceeds the distance measurement value LB obtained by the communication device 210B, the control device 220 decides that the portable device 100 is located on the left side of the vehicle 202. In this case, the control device 220 decides based on equation (3) whether or the second condition is satisfied.

That is, the control device 220 may estimate whether or not the portable device 100 is located inside the vehicle interior according to a conditional expression indicated by a following equation.

$$\begin{matrix}[ Mathematical 4 ] & \\ AND \{ \begin{matrix}{L}_{A} + {L}_{B} \geq {Th}_{1} \\ OR \{ \begin{matrix}if {L}_{A} \leq {L}_{B} : {L}_{C} + {L}_{D} \geq {Th}_{2 R} \\ if {L}_{A} > {L}_{B} : {L}_{E} + {L}_{F} \geq {Th}_{2 L}\end{matrix}\end{matrix} & ( 4 )\end{matrix}$$

When equation (1) is satisfied and one of equations (2) and (3) is satisfied as indicated in equation (4), the control device 220 decides that the portable device 100 is located inside the vehicle interior.

(4) Flow of Process

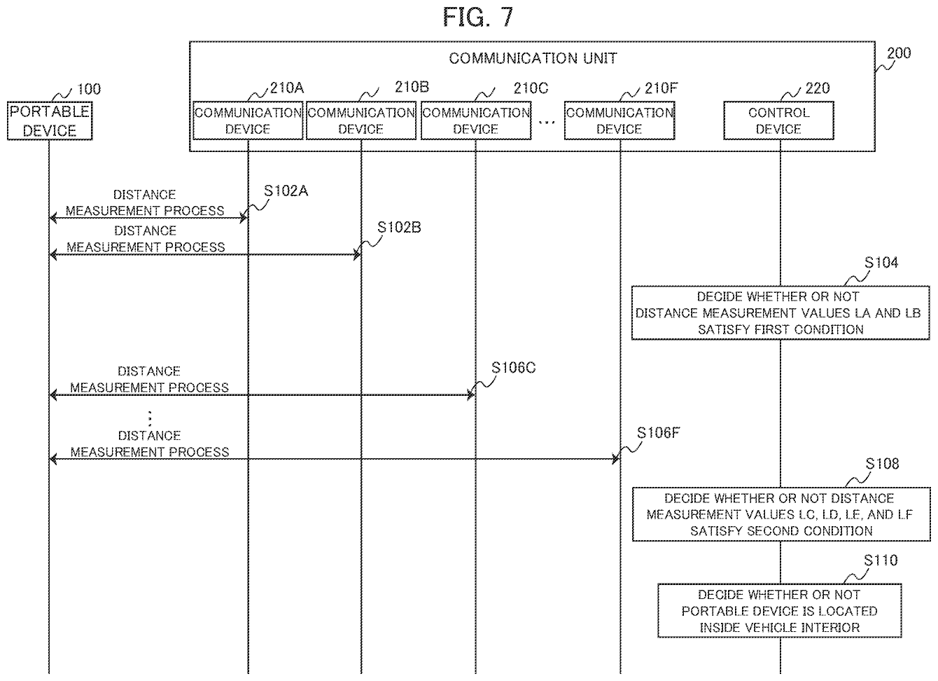

FIG. 7 is a sequence diagram illustrating an example of a flow of a position estimation process executed by the system 1 according to the present embodiment. The portable device 100 and the communication unit 200 are involved in this sequence.

As illustrated in FIG. 7, the portable device 100 and the communication device 210A first perform the distance measurement process (step S102A). The distance measurement process is as described above with reference to FIG. 2. The control device 220 obtains the distance measurement value LA that is obtained by the distance measurement process and indicates a distance between the portable device 100 and the communication device 210A.

Next, the portable device 100 and the communication device 210B perform the distance measurement process (step S102B). The control device 220 obtains the distance measurement value LB that is obtained by the distance measurement process and indicates a distance between the portable device 100 and the communication device 210B.

Furthermore, the control device 220 decides whether or not the distance measurement value LA and the distance measurement value LB satisfy the first condition (step S104). For example, the control device 220 decides whether or not above equation (1) is satisfied.

Next, the portable device 100 and the communication device 210C perform the distance measurement process (step S106C). The control device 220 obtains the distance measurement value LC that is obtained by the distance measurement process and indicates a distance between the portable device 100 and the communication device 210C.

Although omitted in FIG. 7, the portable device 100 and the communication device 210D also perform the distance measurement process. The control device 220 obtains the distance measurement value LD that is obtained by the distance measurement process and indicates a distance between the portable device 100 and the communication device 210D. Similarly, as for the portable device 100 and the communication device 210E, too, the control device 220 that performs the distance measurement process obtains the distance measurement value LE that is obtained by the distance measurement process and indicates a distance between the portable device 100 and the communication device 210E.

Subsequently, the portable device 100 and the communication device 210F perform the distance measurement process (step S106F). The control device 220 obtains the distance measurement value LF that is obtained by the distance measurement process and indicates a distance between the portable device 100 and the communication device 210F.

Furthermore, the control device 220 decides whether or not the distance measurement values LC, LD, LE and LF satisfy the second condition (step S108). For example, the control device 220 decides whether or not above equation (2) or equation (3) is satisfied.

Subsequently, the control device 220 decides whether or not the portable device 100 is located inside the vehicle interior (step S110). When, for example, both of the first condition and the second condition are satisfied, the control device 220 decides that the portable device 100 is located inside the vehicle interior. On the other hand, when at least one of the first condition and the second condition is not satisfied, the control device 220 decides that the portable device 100 is not located inside the vehicle interior.

Note that, when it is decided in step S104 that the first condition is not satisfied, steps S106C to S108 may be omitted. In this case, it is possible to improve responsiveness. The responsiveness described herein refers to how fast whether or not the portable device 100 is located inside the vehicle interior is decided after the distance measurement process is started.

### 3. Supplementary Explanation

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples or alteration examples can be arrived at within the scope of the technical idea recited in the claims, and these change examples and alteration examples also naturally belong to the technical scope of the present invention.

For example, although the above embodiment has described the example where the spaces in the vicinity of the left and right doors of the vehicle 202 are the non-target spaces, and the second virtual spaces corresponding to the non-target spaces are set, the present invention is not limited to this example. For example, the second virtual space corresponding to the rear door of the vehicle 202 may be set. In this case, that the sum of the distance measurement value of the communication device 210C and the distance measurement value of the communication device 210D is equal to or more than the second threshold may be the second condition.

For example, although the above embodiment has described the example where the second position fixed type communication devices are arranged at the bumpers, the present invention is not limited to this example. In an example, the second position fixed type communication devices may be arranged at headlights and taillights of the vehicle 202. Note that the headlights are light emitting devices that are provided at a front side of the vehicle 202. The taillights are light emitting devices that are provided at a rear side of the vehicle 202. In another example, the second position fixed type communication devices may be arranged at side mirror parts of the vehicle 202. Note that the side mirrors are mirrors that are arranged on outer sides of the front seat doors of the vehicle 202.

For example, although the above embodiment has described the example where the communication devices 210 calculate the distance measurement values, the present invention is not limited to this example. For example, the control device 220 may calculate a distance measurement value. In this case, the communication devices 210 report the information that indicates ΔT1 and ΔT2 to the control device 220.

For example, although the above embodiment has described that the information that indicates the time ΔT1 from the transmission time of the first distance measurement signal to the reception time of the second distance measurement signal in the portable device 100 is included in the data signal, the present invention is not limited to this example. The data signal only needs to include information related to the transmission time of the first distance measurement signal and the reception time of the second distance measurement signal. Another example of information included in the data signal will be described below.

The another example of the information included in the data signal is information that indicates the transmission time of the first distance measurement signal and the reception time of the second distance measurement signal in the portable device 100. That is, the portable device 100 may transmit time stamps of a start time and an end time of ΔT1 without calculating ΔT1.

The another example of the information included in the data signal is information that indicates a distance between the portable device 100 and the communication device 210 calculated based on the time from the transmission time of the first distance measurement signal to the reception time of the second distance measurement signal. That is, the portable device 100 may calculate the distance between the portable device 100 and the communication device 210, and transmit the information that indicates the calculated distance to the communication device 210. When, for example, ΔT2 is a fixed value, the portable device 100 can calculate the distance measurement value by measuring ΔT1.

For example, although the above embodiment has described the example where the portable device 100 transmits the first distance measurement signal, the present invention is not limited to this example. For example, the communication device 210 may transmit the first distance measurement signal. In this case, when receiving the first distance measurement signal, the portable device 100 transmits the second distance measurement signal as a response to the first distance measurement signal. Furthermore, the portable device 100 transmits the data signal including information that indicates the time ΔT2 from the reception time of the first distance measurement signal to the reception time of the second distance measurement signal. On the other hand, the communication device 210 calculates a distance measurement value based on the time ΔT1 from the transmission time of the first distance measurement signal to the reception time of the second distance measurement signal and the time ΔT2 included in the data signal.

For example, although the above embodiment has described the example where the distance measurement value is calculated based on the propagation time, the present invention is not limited to this example. For example, the distance measurement value may be calculated based on the radio field strength.

For example, although the above embodiment has described the example where the UWB is used as wireless communication standards, the present invention is not limited to this example. In one example, wireless communication standards that use a signal of the UHF band and a signal of the LF band may be used. In another example, wireless communication standards that use Wi-Fi (registered trademark), Near Field Communication (NFC) and an infrared ray may be used.

For example, although the above embodiment has described the example where the control device 220 is included in the communication unit 200, the present invention is not limited to this example. In one example, the control device 220 may be included in the portable device 100. In another example, the control device 220 may be included in another device other than the portable device 100 and the communication unit 200.

For example, although the above embodiment has described the example where the communication unit 200 is a communication device that is mounted on the vehicle, the present invention is not limited to this example. The communication unit 200 may be mounted on an arbitrary movable body such as an airplane or a ship other than the vehicle. In this regard, the movable body refers to a device that moves.

For example, although the above embodiment has described the example where the present invention is applied to the smart entry system, the present invention is not limited to this example. The present invention is applicable to arbitrary systems that perform wireless communication. The present invention is applicable to, for example, a pair including two arbitrary devices of a portable device, a vehicle, a smartphone, a drone, a house, and a home electric appliance. Note that the pair may include two devices of the same type or may include two devices of different types.

Note that, a series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into random access memory (RAM), and executed by a processor such as a CPU. The recording medium may be a magnetic disk, an optical disc, a magneto-optical disc, flash memory, or the like. Alternatively, the above-described computer program may be distributed via a network without using the recording medium, for example.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

### REFERENCE SIGNS LIST

1 system
100 portable device
110 wireless communication section
120 storage section
130 control section
200 communication unit
202 vehicle
210 communication device
211 wireless communication section
212 intra-unit communication section
213 storage section
214 control section
220 control device
222 intra-unit communication section
223 storage section
224 control section

1. A control device comprising a control section configured to obtain one or more distance measurement values, and estimate a relative position of a position changeable type communication device with respect to a target space based on the one or more distance measurement values, the one or more distance measurement values being obtained when one or more position fixed type communication devices and the position changeable type communication device perform wireless communication, and indicating a distance between each of the one or more position fixed type communication devices and the position changeable type communication device, the one or more position fixed type communication devices being communication devices whose relative positions with respect to the target space that is a space partitioned by an object are fixed, and the position changeable type communication device being a communication device whose relative position with respect to the target space is changeable.

2. The control device according to claim 1,
wherein the control section estimates whether or not the position changeable type communication device is located inside the target space to estimate the relative position of the position changeable type communication device with respect to the target space.

3. The control device according to claim 2,
wherein the control section decides whether or not the distance measurement values satisfy a first condition, and thereby estimates whether or not the position changeable type communication device is located inside the target space, the first condition being a condition that the distance measurement values satisfy when the position changeable type communication device is located inside a first virtual space that is a virtual space at least part of which overlaps the target space.

4. The control device according to claim 3, wherein
the one or more position fixed type communication devices include one or more first position fixed type communication devices that are the position fixed type communication devices arranged inside the target space, and
the control section decides whether or not the one or more distance measurement values satisfy the first condition to decide whether or not the distance measurement values satisfy the first condition, the one or more distance measurement values indicating a distance between each of the one or more first position fixed type communication devices and the position changeable type communication device.

5. The control device according to claim 4,
wherein the control section decides whether or not a sum of the one or more distance measurement values is equal to or less than a first threshold to decide whether or not the distance measurement values satisfy the first condition, the one or more distance measurement values indicating the distance between each of the one or more first position fixed type communication devices and the position changeable type communication device.

6. The control device according to claim 4, wherein
the position fixed type communication devices are mounted on a vehicle, and
the first position fixed type communication devices are arranged between an end part on a side of a traveling direction of the vehicle and an end part on a side of an opposite direction to the traveling direction of the vehicle.

7. The control device according to any one of claims 3 to 6 claim 3,
wherein the control section decides whether or not the distance measurement values satisfy a second condition, thereby estimates whether or not the position changeable type communication device is located in a non-target space, and estimates that, when estimating that the position changeable type communication device is located in the non-target space, the position changeable type communication device is not located in the target space, the second condition being a condition that the distance measurement values satisfy when the position changeable type communication device is located outside a second virtual space that is a virtual space at least part of which overlaps the non-target space that is a space outside the target space.

8. The control device according to claim 7, wherein
the one or more position fixed type communication devices include one or more second position fixed type communication devices that are the position fixed type communication devices arranged outside the target space, and
the control section decides whether or not the one or more distance measurement values satisfy the second condition to decide whether or not the distance measurement values satisfy the second condition, the one or more distance measurement values indicating a distance between each of the one or more second position fixed type communication devices and the position changeable type communication device.

9. The control device according to claim 8,
wherein the control section decides whether or not a sum of the one or more distance measurement values is equal to or more than a second threshold to decide whether or not the distance measurement values satisfy the second condition, the one or more distance measurement values indicating the distance between each of the one or more second position fixed type communication devices and the position changeable type communication device.

10. The control device according to claim 8 or 9, wherein
the position fixed type communication devices are mounted on a vehicle, and
the second position fixed type communication devices are arranged at each of an end part on a side of a traveling direction of the vehicle and an end part on a side of an opposite direction to the traveling direction of the vehicle.

11. The control device according to claim 8, wherein
the position fixed type communication devices are mounted on a vehicle, and
the second position fixed type communication devices are arranged at an end part in a direction perpendicular to a traveling direction of the vehicle.

12. The control device according to claim 7,
wherein, when both of the first condition and the second condition are satisfied, the control section estimates that the position changeable type communication device is located inside the target space.

13. The control device according to claim 1, wherein
the position fixed type communication devices are mounted on a vehicle,
the position changeable type communication device is a device that a user of the vehicle carries to use, and
the target space is a vehicle interior that is a space provided in the vehicle for the user to get on the vehicle.

14. (canceled)

15. A control system comprising:
one or more position fixed type communication devices that are communication devices whose relative positions with respect to a target space that is a space partitioned by an object are fixed, and
a control device configured to obtain one or more distance measurement values, and estimate the relative position of a position changeable type communication device with respect to the target space based on the one or more distance measurement values, the one or more distance measurement values being obtained when each of the one or more position fixed type communication devices and the position changeable type communication device perform wireless communication, and indicating a distance between each of the one or more position fixed type communication devices and the position changeable type communication device, and the position changeable type communication device being a communication device whose relative position with respect to the target space is changeable.

16. A non-transitory computer readable medium having a program stored therein, the program causing a computer to function as a control section configured to obtain one or more distance measurement values, and estimate a relative position of a position changeable type communication device with respect to a target space based on the one or more distance measurement values, the one or more distance measurement values being obtained when one or more position fixed type communication devices and the position changeable type communication device perform wireless communication, and indicating a distance between each of the one or more position fixed type communication devices and the position changeable type communication device, the one or more position fixed type communication devices being communication devices whose relative positions with respect to the target space that is a space partitioned by an object are fixed, and the position changeable type communication device being a communication device whose relative position with respect to the target space is changeable.
